(19) United States
(12) Patent Application Publication
(10) Pub. No.: US 2013/0100145 A1
(43) Pub. Date: Apr. 25, 2013

(54) ELECTROMECHANICAL SYSTEMS DEVICE

(71) Applicants: Fan Zhong, Fremont, CA (US); Yi Tao, San Jose, CA (US)

(72) Inventors: Fan Zhong, Fremont, CA (US); Yi Tao, San Jose, CA (US)

(73) Assignee: QUALCOMM MEMS Technologies, Inc., San Diego, CA (US)

(21) Appl. No.: 13/278,603

(22) Filed: Oct. 21, 2011

(51) Int. Cl. G06T 1/00; G02B 26/00; H01J 9/00

(52) U.S. Cl. 345/501; 445/24; 359/292

(57) ABSTRACT

This disclosure provides systems, methods, and apparatus for EMS devices. In one aspect, an EMS device includes at least one movable layer configured to move relative to one or more electrodes. The at least one movable layer can include a first conductive layer, a second conductive layer, and a non-conductive layer disposed between the first conductive layer and the second conductive layer. In some implementations, the movable layer can include at least one conductive via electrically connecting the first conductive layer and the second conductive layer through the non-conductive layer.

### TECHNICAL FIELD

This disclosure relates to movable layers for use in electromechanical systems.

### DESCRIPTION OF THE RELATED TECHNOLOGY

Electromechanical systems (EMS) include devices having electrical and mechanical elements, actuators, transducers, sensors, optical components (including minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a plurality of display elements disposed in a line. Each display element includes a partially transmissive and partially reflective optical stack. Each display element also includes a movable layer disposed over at least a portion of the optical stack so as to at least partially define a cavity between the movable layer and the optical stack. The movable layer is at least partially reflective and includes a first conductive layer, a second conductive layer, and a non-conductive layer disposed between the first conductive layer and the second conductive layer. The first conductive layer of each display element is electrically connected to the first conductive layer of any adjacent display element in the line of display elements. Likewise, the second conductive layer of each display element is electrically connected to the second conductive layer of any adjacent display element in the line of display elements. At least one of the plurality of display elements includes at least one conductive via disposed in the movable layer through the non-conductive layer which electrically connects the first conductive layer and the second conductive layer.

In one aspect, the optical stack can include a first electrode, and the first conductive layer and the second conductive layer can form at least a portion of a second electrode. The movable layer can be configured to move between an actuated position and a relaxed position based on a voltage applied across the first and second electrodes. In another aspect, each of the plurality of display elements can include at least one conductive via electrically connecting the first conductive layer and the second conductive layer. In one aspect, at least one display element can include more than one conductive via electrically connecting the first conductive layer and the second conductive layer.

In one aspect, the at least one conductive via can include a conductive via disposed in a tether area of at least one of the plurality of display elements. In one aspect, the at least one conductive via can include a conductive via disposed along an edge of at least one of the plurality of display elements. In one aspect, the at least one conductive via can be structured to have one of an oval-shaped cross-sectional area, a rectangular cross-sectional area, and a circular cross-sectional area.

Another innovative aspect of the subject matter described in this disclosure can be implemented in method of manufacturing an apparatus including forming a plurality of display elements disposed in a line. Forming each of the plurality of display elements includes forming a partially transmissive and partially reflective optical stack, depositing a sacrificial layer over the optical stack, and forming a movable layer over the sacrificial layer and optical stack such that when the sacrificial layer is removed the movable layer is movable towards and away from the optical stack. Forming the movable layer includes forming a first conductive layer, forming a non-conductive layer over the first conductive layer, and forming a second conductive layer over the non-conductive layer. The first conductive layer of each display element is electrically connected to the first conductive layer of any adjacent display element in the line of display elements and the second conductive layer of each display element is electrically connected to the second conductive layer of any adjacent display element in the line of display elements. The method also includes forming at least one conductive via in the movable layer of at least one display element between the first conductive layer and the second conductive layer.

In one aspect, forming the at least one conductive via can include etching the non-conductive layer of at least one of the display elements between the first conductive layer of the at least one display element and a surface of the non-conductive layer of the at least one display element opposite to the first conductive layer. In this aspect, forming the at least one conductive via also can include forming the second conductive layer over the non-conductive layer of the at least one display element.

In one aspect of the method, the optical stack can include a first electrode, the first conductive layer and the second conductive layer can form at least a portion of a second electrode, and the movable layer can be configured to move between an actuated position and a relaxed position based on a voltage applied across the first and second electrodes. In one aspect, forming the at least one conductive via can include forming a conductive via disposed in a tether area of at least one of the plurality of display elements. In one aspect, forming the at least one conductive via can include forming a conductive via disposed along an edge of at least one of the plurality of display elements.

Another innovative aspect of the subject matter described in this disclosure can be implemented in an apparatus including a plurality of display elements disposed in a line. Each display element includes means for partially transmitting and partially reflecting light. Each display element also includes a movable layer disposed over at least a portion of the partially transmitting and partially reflecting means so as to define a cavity between the movable layer and the partially transmitting and partially reflecting means. The movable layer is at least partially reflective and includes first means for conducting electricity, second means for conducting electricity, and a non-conductive layer disposed between the first conductive means and the second conductive means. The first conductive means of each display element are connected to the first conductive means of any adjacent display element in the line of display elements. The second conductive means of each display element are electrically connected to the second conductive means of any adjacent display element in the line of display elements. At least one of the display elements includes at least one means for electrically connecting the first conductive means and the second conductive means through the non-conductive layer.

In one aspect, the first conductive means includes a first conductive layer. In one aspect, the second conductive means includes a second conductive layer. In one aspect, the electrically connecting means includes at least one conductive via.

Another innovative aspect of the subject matter described in this disclosure can be implemented in an apparatus including a plurality of partially transmissive and partially reflective optical stacks. The apparatus also includes a movable layer extending over each of the plurality of optical stacks and defining a plurality of display elements between each of the optical stacks and the movable layer. At least a portion of the movable layer is movable towards and away from at least one of the plurality of optical stacks based on a voltage applied across the at least one of the plurality of optical stacks and the movable layer. The movable layer includes a first conductive layer, a second conductive layer, a non-conductive layer disposed between the first conductive layer and the second conductive layer, and at least one conductive via electrically connecting the first conductive layer and the second conductive layer through the non-conductive layer.

In one aspect, the movable layer can include more than one conductive via electrically connecting the first conductive layer and the second conductive layer. In one aspect, the at least one conductive via can include a conductive via disposed between two of the plurality of display elements. In one aspect, the at least one conductive via can include a conductive via disposed in the center of at least one of the plurality of display elements. In one aspect, the at least one conductive via can be structured to have one of an oval-shaped cross-sectional area, a rectangular cross-sectional area, and a circular cross-sectional area. In one aspect, the movable layer can include one slot disposed between two adjacent display elements. In one aspect, the at least one conductive via can be disposed in the at least one slot.

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of an electrical schematic of a movable layer having a first conductive layer and a second conductive layer.

FIG. 9B shows an example of an electrical schematic of a movable layer having a first conductive layer and a second conductive layer that are electrically connected to one another by a plurality of conductive vias.

FIG. 9C shows the example electrical schematic of FIG. 9A with a break in the first conductive layer between the ends of the movable layer and a break in the second conductive layer between the ends of the movable layer.

FIG. 9D shows the example electrical schematic of FIG. 9B with a break in the first conductive layer between the ends of the movable layer and a break in the second conductive layer between the ends of the movable layer.

FIG. 10A shows a bottom plan view of a portion of an example of an EMS device having a plurality of movable layers each having a plurality of conductive vias extending between the first and second conductive layers in the centers of the display elements formed by the movable layers and a plurality of underlying electrodes.

FIG. 10B shows a cross-sectional view of the example EMS device of FIG. 10A taken along line 10B-10B.

FIG. 11A shows a flow diagram illustrating an example method of manufacturing an apparatus.

FIGS. 11B-11E show cross-sectional views of an example process of manufacturing the EMS device of FIGS. 10A and 10B in accordance with the example method of FIG. 11A.

FIG. 12 shows a bottom plan view of a portion of an example of an EMS device having a plurality of movable layers each having a plurality of conductive vias extending between the first conductive layer and the second conductive layer along opposite edges of the display elements formed by the movable layers and a plurality of underlying electrodes.

FIG. 13 shows a bottom plan view of a portion of an example of an EMS device having a plurality of movable layers each having a plurality of conductive vias extending between the first conductive layer and the second conductive layer along the four edges of the display elements formed by the movable layers and a plurality of underlying electrodes.

FIG. 14 shows a bottom plan view of a portion of an example of an EMS device having a plurality of movable layers each having a plurality of conductive vias extending between the first conductive layer and the second conductive layer in pairs along opposite edges of the display elements formed by the movable layers and a plurality of underlying electrodes.

FIG. 15 shows a bottom plan view of a portion of an example of an EMS device having a plurality of movable layers each having a plurality of circular conductive vias extending between the first conductive layer and the second conductive layer over the black mask structures of the display.

FIG. 16 shows a bottom plan view of a portion of an example of an EMS device having a plurality of movable layers each having a plurality of oval shaped conductive vias extending between the first conductive layer and the second conductive layer over the black mask structures of the display.

FIG. 17 shows a bottom plan view of a portion of an example of an EMS device having a plurality of movable layers each having a plurality of conductive vias extending through the non-conductive layer between the first conductive layer and the second conductive layer.

FIGS. 18A and 18B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Reflective display devices, for example, interferometric modulator devices, can include one or more pixels which can each have one or more display elements or sub-pixels. Each display element can include a movable layer configured to move with respect to a light absorbing layer or stack, which may be referred to herein simply as an “optical stack.” Each display element also can include an optical resonant cavity disposed between the movable layer and the optical stack. The movable layer, optical stack, and optical resonant cavity can be configured to selectively absorb and/or reflect light incident thereon using principles of optical interference. The movable layer can be moved between two or more positions, which changes the size of the optical resonant cavity. Changing the size of the optical resonant cavity can affect the reflectance of the display element and correspondingly, the reflectance of the interferometric modulator device as a whole.

In some implementations, the movable layer includes a first conductive layer, a second conductive, and a non-conductive (or spacer) layer disposed between the first conductive layer and the second conductive layer. The first conductive layer can be configured to reflect light and the second conductive layer can be configured to balance mechanical stresses on the movable layer and to provide symmetry to the movable layer. The first conductive layer and the second conductive layer are typically electrically connected (e.g., shorted) to each other at the ends of the movable layer. The non-conductive layer can be configured to provide a desired rigidity to the movable layer. However, the non-conductive layer also can electrically isolate the first conductive layer from the second conductive layer between ends of the movable layer which can be electrically connected. The electrical separation of the first conductive layer and the second conductive layer between the ends of the movable layer can result in an effective capacitance measured between the first conductive layer and the second conductive layer when a signal is provided to the movable layer and a charge builds on the first conductive layer and the second conductive layer.

In some implementations, the movable layer can be moved towards the optical stack by receiving a data signal which applies a voltage between the movable layer and the optical stack. In such implementations, the effective resistance and effective capacitance of the movable layer can affect the responsiveness of the movable layer when the data signal is provided to the movable layer. For example, a movable layer with a higher effective resistance and effective capacitance can have a higher RC delay than a movable layer having a lower effective resistance and effective capacitance.

In some implementations disclosed herein, a movable layer in an interferometric modulator device can include one or more conductive vias extending between the first conductive layer and the second conductive layer through the non-conductive layer between the ends of the movable layer. In this way, such movable layers can have decreased effective resistances and effective capacitances as compared with similar movable layers that do not include conductive vias extending through the non-conductive layer that electrically connect the first and second conductive layers.

Particular implementations of the subject matter described in this disclosure can be implemented to realize one or more of the following potential advantages. For example, movable layers having one or more conductive vias extending through the non-conductive layer so as to electrically connect the first conductive layer and the second conductive layer can have lower effective resistances and effective capacitances than other movable layers that do not include such conductive vias. When a movable layer having one or more conductive vias extending between the first conductive layer and the second conductive layer is incorporated in an EMS device, such as an interferometric modulator device, the device can be more responsive than other EMS devices, e.g., interferometric modulator devices. That is to say, a signal transmitted through such a movable layer may experience a lower RC delay than a movable layer that does not include conductive vias extending through the non-conductive layer between the first and second conductive layers. An increase in responsiveness or corresponding decrease in RC delay can improve the frame-rate of an interferometric modulator device. Further, a decrease in effective resistance and effective capacitance of a movable layer can decrease cross-talk between components of the interferometric modulator device. As cross-talk can undesirably lead to false release and/or false actuation of a movable layer, decreasing cross-talk can increase the usable-voltage window that may be utilized to actuate and/or release a movable layer-. Moreover, conductive vias extending through the non-conductive layer so as to electrically connect the first and second conductive layers can serve to maintain an electrical path through the movable layer when interferometric modulator device is incorporated in a touch device. In such devices, a hard touch may break a portion of the first conductive layer and/or second conductive layer. Conductive vias extending between the first conductive layer and the second conductive layer can preserve the electrical path across the break points of the movable layer.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

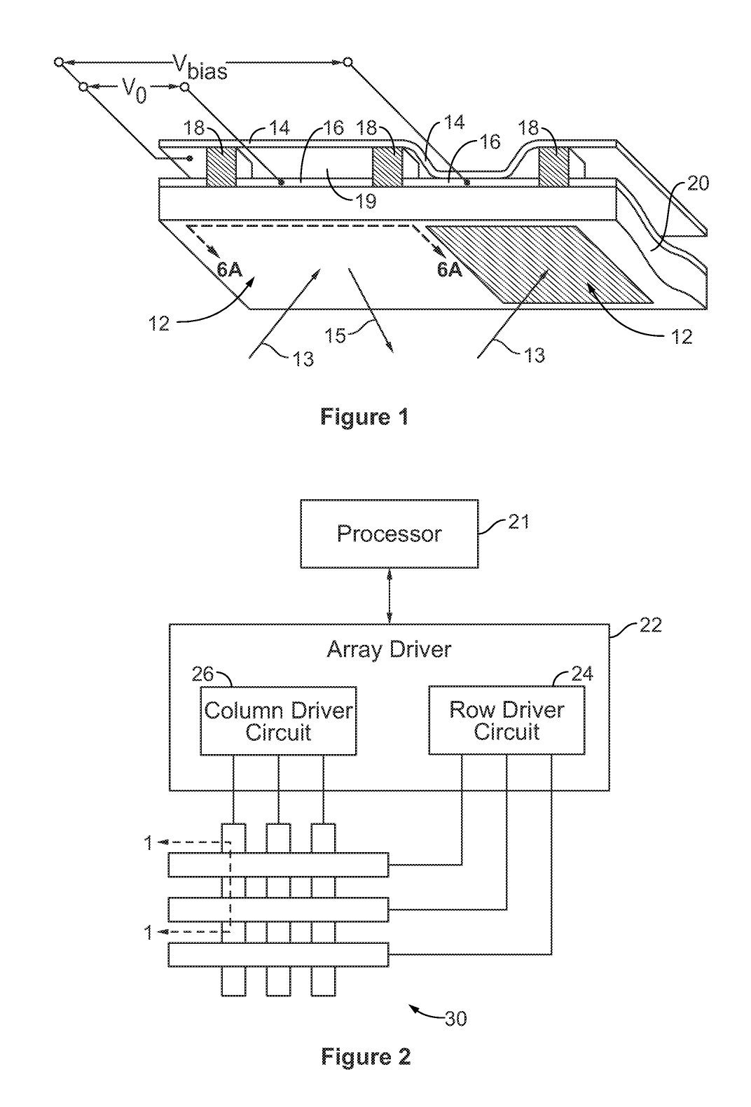

FIG. 1 shows an example of an isometric view depicting two adjacent pixels in a series of pixels of an IMOD display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

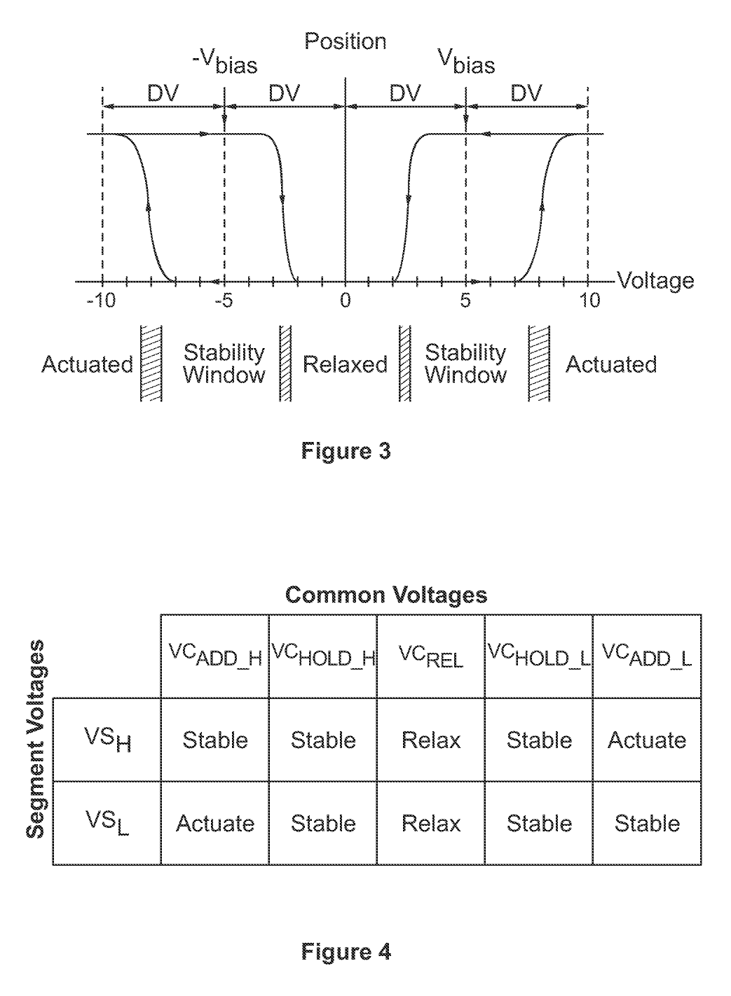

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

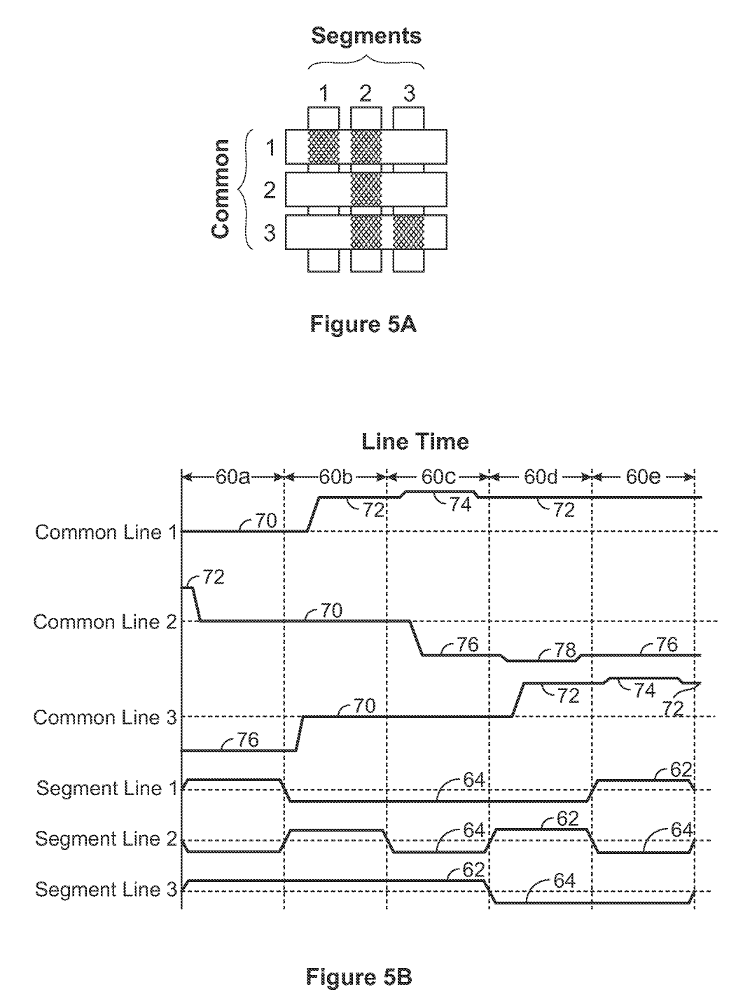

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

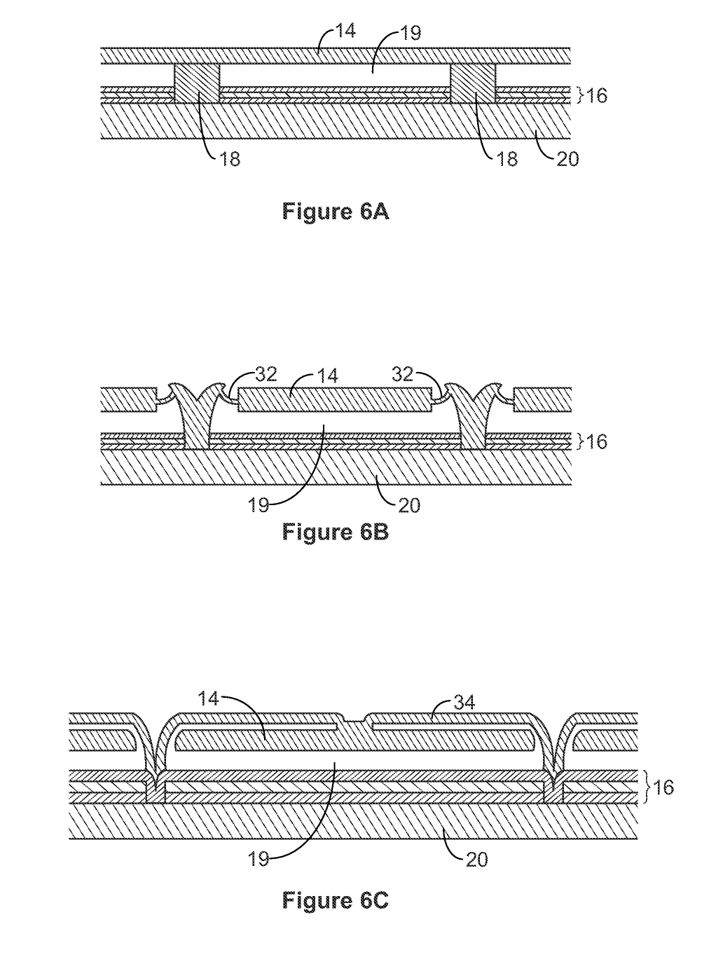

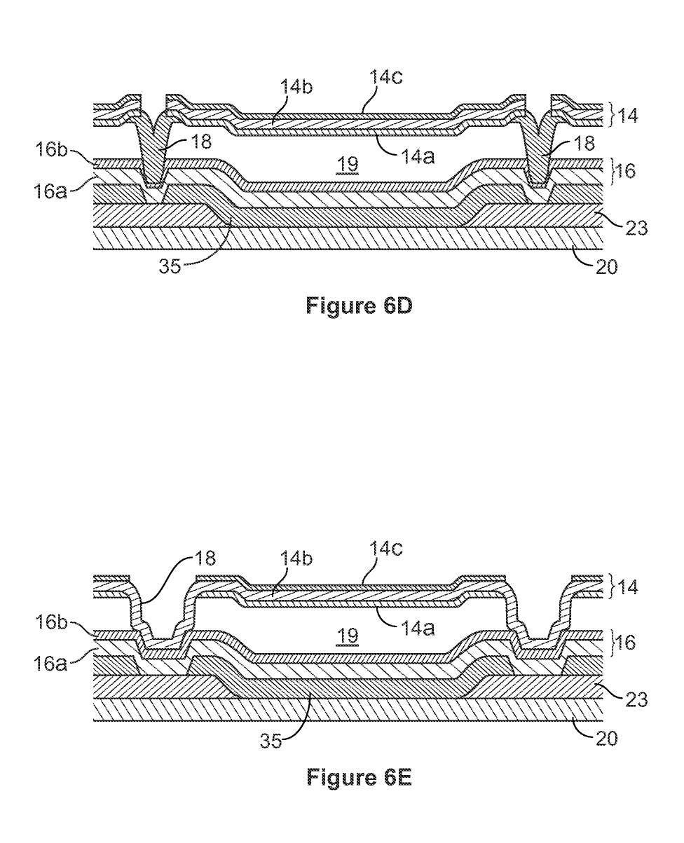

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

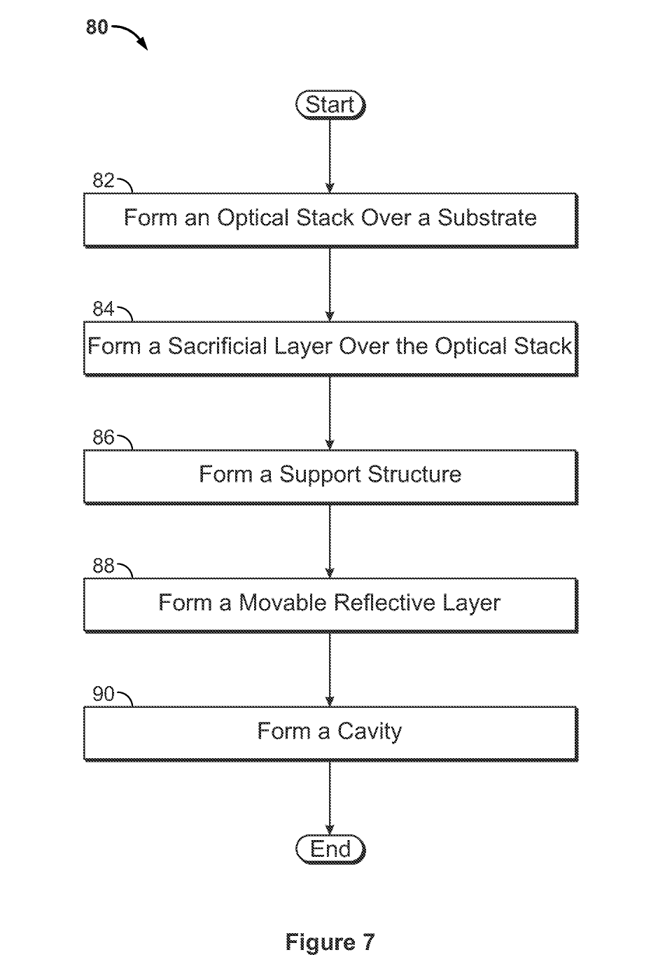

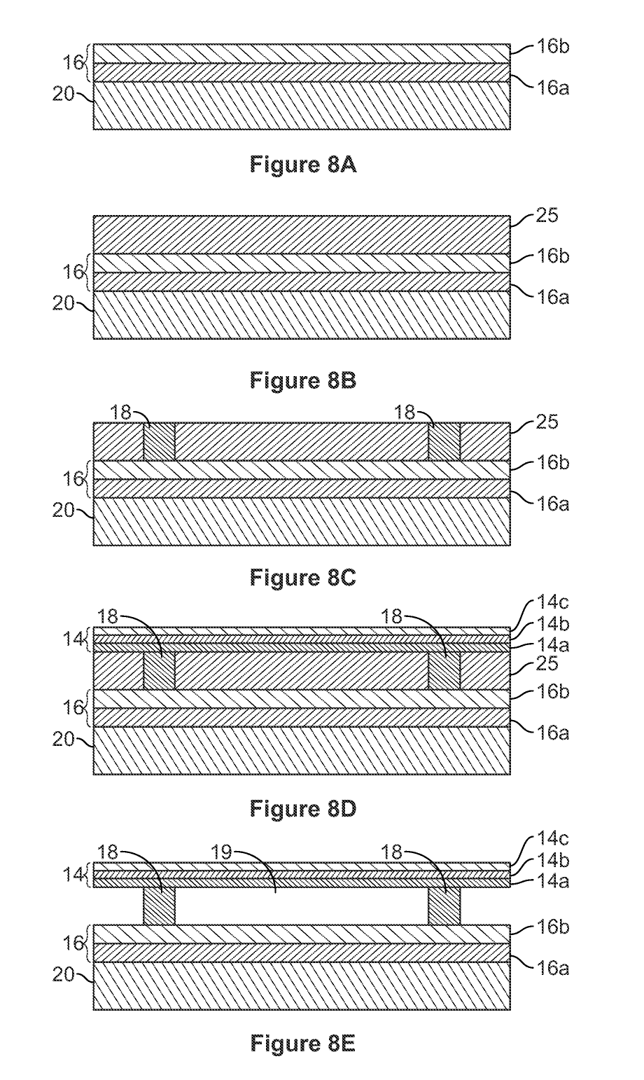

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As discussed above, in some implementations of IMOD devices it can be advantageous to incorporate movable layers having one or more conductive vias extending through the non-conductive layer between the first conductive layer and the second conductive layer. In this way, the first conductive layer and the second conductive layer can be electrically connected or shorted to one another between the ends of the movable layer. Thus, such movable layers can have effective resistances, effective capacitances, and overall impedances that are less than other movable layers that do not include any conductive vias extending through the non-conductive layer. Further, movable layers incorporating one or more conductive vias as described below can preserve an electrical path through the movable layer even after a break has formed in the first conductive layer and/or second conductive layer.

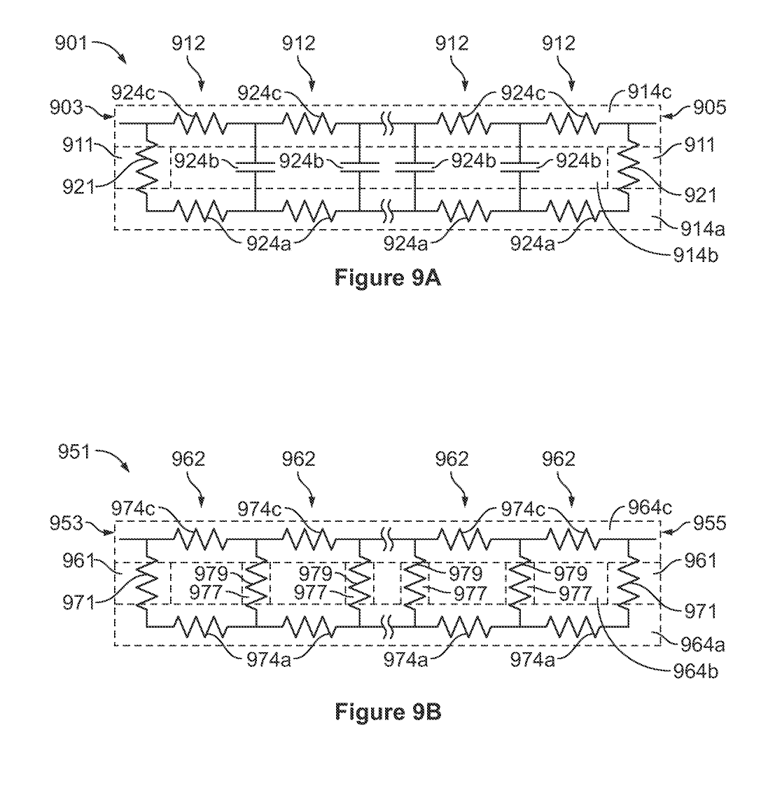

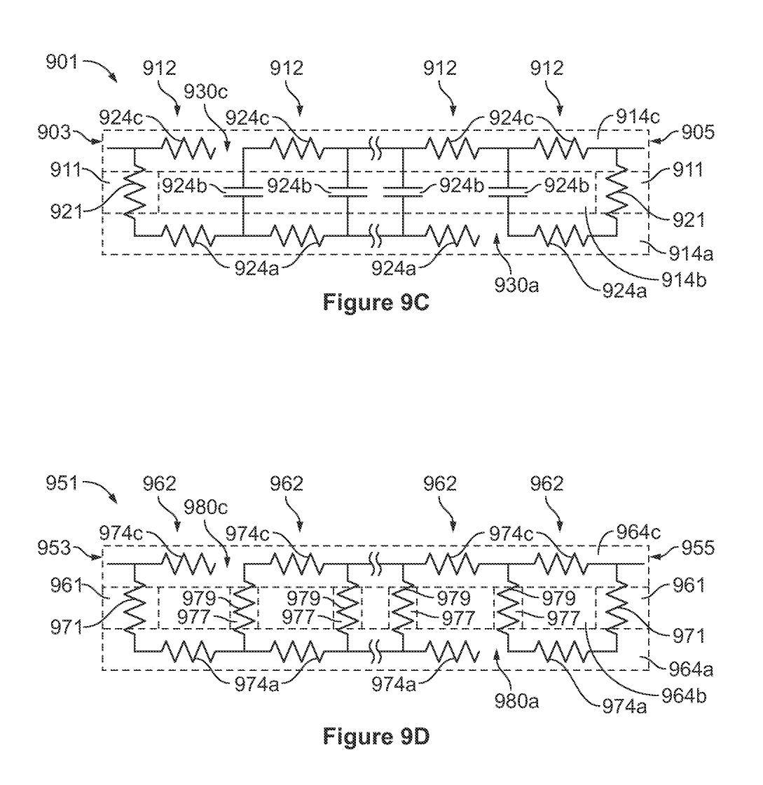

FIG. 9A shows an example of an electrical schematic of a movable layer 901 having a first conductive layer 914a and a second conductive layer 914c. The movable layer 901 and other implementations of movable layers described herein can be, for example, part of a bi-stable or an analog EMS device, including an interferometric modulator. The first conductive layer 914a can be electrically connected to the second conductive layer 914c at the ends 903 and 905 of the movable layer 901 by end connections 911. The movable layer 901 can be spaced apart from one or more optical stacks (not shown) in an interferometric modulator device so as to form display elements 912 including the movable layer 901 and the optical stacks. For example, the movable layer 901 can be disposed below one or more optical stacks and configured to move relative to the one or more optical stacks. As illustrated, portions of the first conductive layer 914a corresponding to the display elements 912 can form effective resistors 924a that are connected to one another in series between the ends 903 and 905 of the movable layer 901. Similarly, portions of the second conductive layer 914c corresponding to the display elements 912 can form effective resistors 924c that are connected to one another in series between the ends 903 and 905 of the movable layer 901. Additionally, the end connections 911 extending between the first conductive layer 914a and the second conductive layer 914c can each form effective resistors 921 between the first conductive layer 914a and the second conductive layer 914c.

Still referring to FIG. 9A, the movable layer 901 also includes a non-conductive layer 914b disposed between the first conductive layer 914a and the second conductive layer 914c in between the end connections 911. The end connections 911 can include any conductive material capable of electrically connecting the first conductive layer 914a and the second conductive layer 914c. In this implementation, the non-conductive layer 914b extends continuously between the end connections 911 such that effective capacitors 924b are formed between the first conductive layer 914a and the second conductive layer 914c in between the display elements 912. These effective capacitors 924b and the effective resistors 924a, 924c, and 921 of the movable layer 901 can affect the overall impedance of the movable layer 901. That is to say, the capacitors 924b and the effective resistors 924a, 924c, and 921 of the movable layer 901 can affect an opposition to a current or signal passing through the movable layer 901, such as from a column driver circuit.

FIG. 9B shows an example of an electrical schematic of a movable layer 951 having a first conductive layer 964a and a second conductive layer 964c that are electrically connected to one another by a plurality of conductive vias 977. The first conductive layer 964a is also electrically connected to the second conductive layer 964c at the ends 953 and 955 of the movable layer 951 by end connections 961. The movable layer 951 can be spaced apart from one or more optical stacks (not shown) in an interferometric modulator device so as to form display elements 962 between the movable layer 951 and the optical stacks. For example, the movable layer 951 can be disposed below one or more optical stacks and configured to move relative to the one or more optical stacks. As illustrated, portions of the first conductive layer 964a corresponding to the display elements 962 can form effective resistors 974a that are connected to one another in series between the ends 953 and 955 of the movable layer 951. Similarly, portions of the second conductive layer 964c corresponding to the display elements 962 can form effective resistors 974c that are connected to one another in series between the ends 953 and 955 of the movable layer 951. Additionally, the end connections 961 extending between the first conductive layer 964a and the second conductive layer 964c can each form effective resistors 971.

Still referring to FIG. 9B, the movable layer 951 also includes a non-conductive layer 964b disposed between the first conductive layer 964a and the second conductive layer 964c in between the end connections 961. In this implementation, the movable layer 951 includes conductive vias 977 electrically connecting the first conductive layer 964a and the second conductive layer 964c through the non-conductive layer 964b. In this way, one or more effective resistors 979 are formed by the conductive vias 977 between the display elements 962 of the movable layer 951. Because the effective resistors 979 of the conductive vias 977 and the effective resistors 971 are connected in parallel between the first conductive layer 964a and the second conductive layer 964c, the movable layer 951 has a lower overall effective resistance and impedance than the movable layer 901 of FIG. 9A which does not include any conductive vias extending through the non-conductive layer 914b.

In some implementations, an EMS device, such as an IMOD device, may be exposed to physical contact or touch by a user or an implement, such as a pen or stylus. For example, an EMS device can be implemented in an apparatus that includes a touch input surface or interface. In such implementations, the movable layers of the EMS device may be subject to impactful forces arising from the touch or contact and the impactful forces may cause one or more layers of the movable layers to break or separate.

FIG. 9C shows the example electrical schematic of FIG. 9A with a break 930a in the first conductive layer 914a between the ends 903 and 905 of the movable layer 901 and a break 930c in the second conductive layer 914c between the ends 903 and 905 of the movable layer 901. Because the movable layer 901 in FIGS. 9A and 9C does not include one or more conductive vias extending between the first conductive layer 914a and the second conductive layer 914c, the breaks 930a and 930c electrically separate the left and right sides of the movable layer 901 from one another. Thus, a signal provided to the movable layer 901, such as from a driver, may not pass through the movable layer 901 from one end 903 to the other end 905. That is to say, the breaks 930a and 930c can result in the “lineout” of the movable layer 901.

FIG. 9D shows the example electrical schematic of FIG. 9B with a break 980a in the first conductive layer 964a between the ends 953 and 955 of the movable layer 951 and a break 980c in the second conductive layer 964c between the ends 953 and 955 of the movable layer 951. In contrast to the movable layer 901 of FIG. 9A, because the movable layer 951 in FIGS. 9B and 9D includes conductive vias 977 extending between the first conductive layer 964a and the second conductive layer 964c, the movable layer 951 provides an electrical path between the ends 953 and 955 of the movable layer 951 even with the breaks 980. That is to say, even though the movable layer 951 includes breaks 980, a signal provided to the movable layer 951, such as from a driver, may pass through the movable layer 951 from one end 953 to the other end 955 by passing from one of the first conductive layer 964a and the second conductive layer 964c through the conductive vias 977 to the other of the first conductive layer 964a and the second conductive layer 964c.

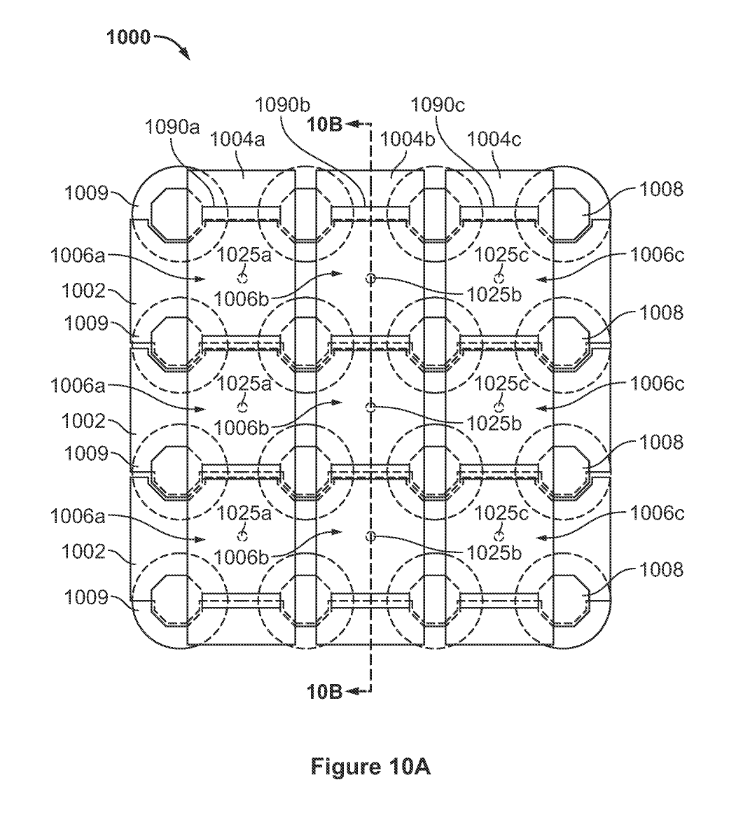

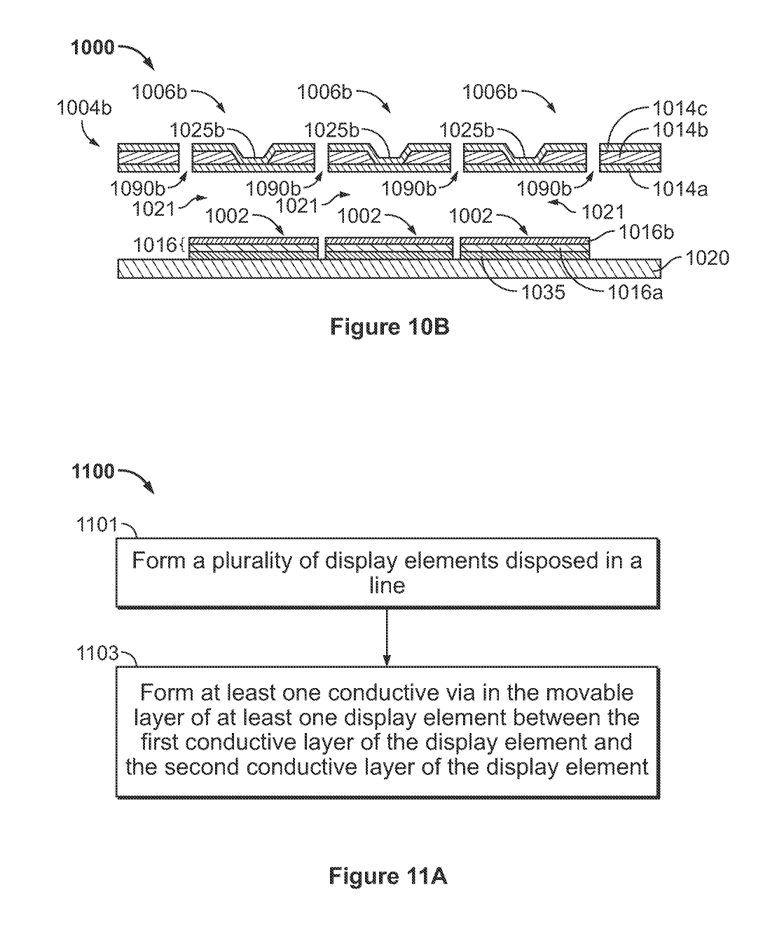

FIG. 10A shows a bottom plan view of a portion of an example of an EMS device 1000 having a plurality of movable layers 1004 each having a plurality of conductive vias 1025 extending between the first conductive layer and second conductive layers in the centers of the display elements 1006a, 1006b, and 1006c formed by the movable layers 1004a, 1004b and 1004c and a plurality of underlying electrodes 1002. As used herein, a bottom plan view of an EMS device refers to a view of the device that is opposite to the side of the device that receives incident light (e.g., a side that is opposite to the substrate 20 illustrated in FIG. 1). As shown, the electrodes 1002 are disposed in rows (depicted horizontally in FIG. 10A) and the movable layers 1004a, 1004b and 1004c are disposed in columns (depicted vertically in FIG. 10A) extending perpendicular to the electrodes 1002. The overlapping portions of the electrodes 1002 and the movable layers 1004a, 1004b and 1004c define the nine display elements 1006 (including three each of display elements 1006a, 1006b and 1006c). Supports 1008 are disposed at corner regions of each display element 1006 and are configured to support edge portions of the movable layers 1004 relative to the electrodes 1002.

In some implementations, the electrodes 1002 can be electrically conductive portions of an optical stack. As such, reference to electrodes 1002 in this and the following discussion will be understood as a reference to the electrically conductive layer(s) of an optical stack, for example, the optical stack 16 illustrated in FIGS. 6A-6E. Although FIG. 10A omits other layers of the optical stack (for example, a partially reflective layer or absorber, and/or one or more transparent dielectric layers) for clarity, other layers can be present as desired for particular applications. The EMS device 1000 also includes optical, or black mask structures 1009 disposed under the electrodes 1002 and movable layers 1004 (e.g., furthest away from the view of FIG. 10A). In some implementations, the black mask structures 1009 can be configured similar to the black mask structure 23 described above with reference to FIGS. 6D and 6E to absorb ambient or stray light in non-active portions of the EMS device 1000, and to improve the optical response of the EMS device 1000 by increasing the contrast ratio.

In the implementation illustrated in FIG. 10A, the movable layers 1004 each include a conductive via 1025 extending through the non-conductive layer between the first conductive layer and the second conductive layer. For example, movable layer 1004a includes three conductive vias 1025a, one being disposed in a center of each of the display elements 1006a formed between the movable layer 1004a and the electrodes 1002. Similarly, movable layer 1004b includes three conductive vias 1025b disposed in the centers of each of the display elements 1006b formed between the movable layer 1004b and the electrodes 1002. Lastly, movable layer 1004c includes three conductive vias 1025c disposed in the centers of each of the display elements 1006c formed between the movable layer 1004c and the electrodes 1002. In such an implementation, the first conductive layer and the second conductive layer of the movable layers 1004 are electrically connected along the length of the movable layers 1004. Thus, the movable layers 1004 can have lower resistances than other movable layers and lineout may be prevented in touch cases as discussed above with reference to FIGS. 9A-9D.

Still referring to FIG. 10A, each movable layer 1004 can include one or more slots or cuts 1090 disposed between supports 1008. In some implementations, the slots 1090 are disposed in the movable layers 1004 between display elements 1006. In this way, the slots 1090 can separate portions of the movable layer 1004 from one another to avoid mechanical cross-talk between the display elements 1006.

FIG. 10B shows a cross-sectional view of the example EMS device 1000 of FIG. 10A taken along line 10B-10B. FIG. 10B also shows insulating layers 1035 disposed between the electrodes 1002 and an underlying substrate layer 1020. The substrate layer 1020 can include any suitable substrate, for example, glass. As discussed above, each electrode 1002 can be an electrically conductive portion of an optical stack 1016 which includes an absorber layer 1016a and a dielectric layer 1016b. Thus, in some implementations, the electrodes 1002 can be the conductive absorber layers 1016a of the optical stacks 1016. In such implementations, the interferometric cavity can be defined by the absorber layer 1016a and the reflective layer 1014a, which can include the dielectric layer 1016b and gaps 1021 between the dielectric layer 1016b and the reflective layer 1014a.

As discussed above with reference to FIG. 10A, the movable layers 1004 of FIG. 10A can include multiple layers. For example, as illustrated in FIG. 10B, movable layer 1004b includes a first conductive layer 1014a, a second conductive layer 1014c, and a non-conductive layer 1014b disposed between the first conductive layer 1014a and the second conductive layer 1014c. Although the non-conductive layer 1014b can include a dielectric material that electrically separates portions of the first conductive layer 1014a and the second conductive layer 1014c, the conductive vias 1025 electrically connect the first conductive layer 1014a and the second conductive layer 1014c through the non-conductive layer 1014b.

Also shown in FIG. 10B are the gaps 1021, which can be, for example, air gaps. The gaps 1021 are defined between the movable layer 1004b and the electrodes 1002. The movable layer 1004b is configured to move relative to the optical stacks 1016 through the gaps 1021 when actuated by an actuation voltage between any of the electrodes 1002 and the movable layer 1004. In some implementations, the movable layer 1004b can be configured to move through the gaps 1021 such that the first conductive layer 1014a contacts a dielectric layer 1016b of one of the optical stacks 1016 when actuated.

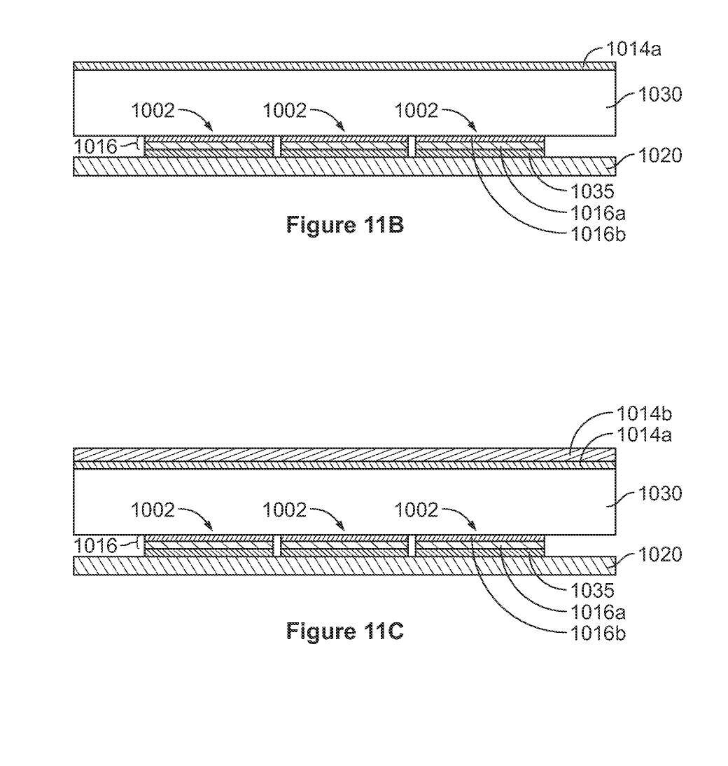

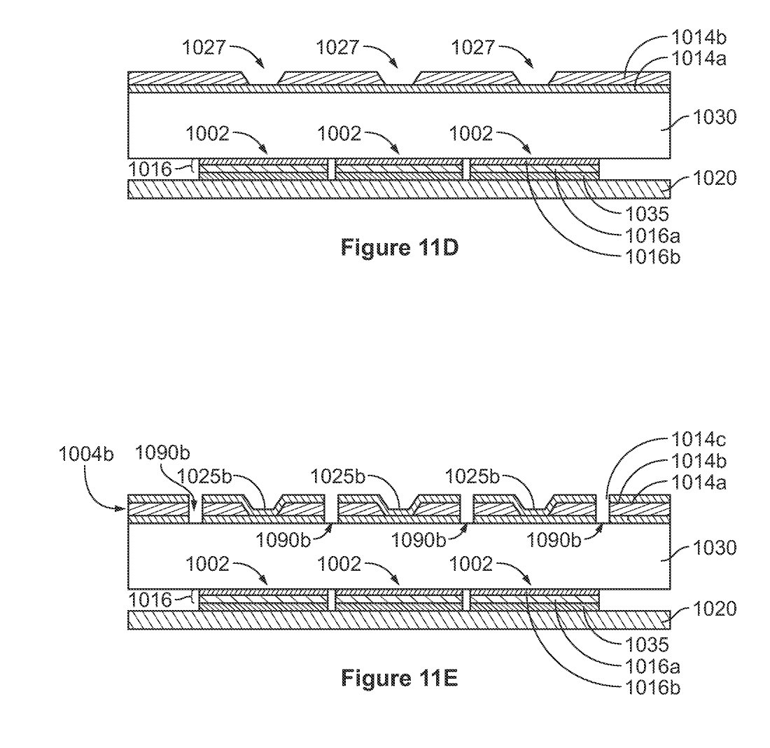

FIG. 11A shows a flow diagram illustrating an example method 1100 of manufacturing an apparatus. The method 1100 can be used to manufacture an EMS device, such as an IMOD device including at least one movable layer having one or more conductive vias extending between the first conductive layer and the second conductive layer. For example, the method 1100 can be used to manufacture the EMS device 1000 of FIGS. 10A and 10B.

As shown in block 1101, the method 1100 includes forming a plurality of display elements disposed in a line. In some implementations forming each of the plurality of display elements includes forming a partially transmissive and partially reflective optical stack. For example, the partially transmissive and partially reflective optical stack can include an absorber layer (such as a partially reflective and partially transmissive layer) and a dielectric layer similar to the optical stack 1016 of FIG. 10B. In some implementations, the absorber layer can include a layer of molybdenum-chromium (MoCr) having a thickness of between 3 nm and 12 nm, for example, 6 nm, although the absorber layer can be thicker or thinner depending on the desired implementation. The dielectric layer can include any suitable non-conductive or dielectric material capable of insulating the absorber layer from a movable layer. For example, the dielectric layer can include SiO₂, silicon oxynitride (SiON), aluminum oxide (Al₂O₃), titanium dioxide (TiO₂), zirconium oxide (ZrO₂), hafnium oxide (HfO₂), indium oxide (In₂O₃), zinc oxide (ZnO), or mixtures thereof.

Forming each of the plurality of display elements also can include depositing a sacrificial layer over the optical stack and forming a movable layer over the sacrificial layer and optical stack. In some implementations, the movable layer can be formed over the sacrificial layer such that when the sacrificial layer is removed, the movable layer is movable towards and away from the optical stack. Forming the movable layer can include forming a first conductive layer, forming a non-conductive layer over the first conductive layer, and forming a second conductive layer. The movable layer can be similar to the movable layer 1004 of FIGS. 10A and 10B.

In some implementations, the first conductive layer can include an aluminum (Al) alloy with about 0.5% copper (Cu), or another reflective and conductive material. The second conductive layer can include the same material(s) as the first conductive layer or can be formed of different material(s). For example, the second conductive layer can include an Al alloy with about 0.5% Cu, or another conductive material. In some implementations, the material(s) of the first conductive layer and the second conductive layer can be selected such that the first conductive layer and the second conductive layer have a substantially similar coefficient of thermal expansion. For example, the first conductive layer can have a coefficient of thermal expansion that is within 20% of a coefficient of thermal expansion of the second conductive layer. In this way, the first conductive layer and the second conductive layer can act to balance the movable layer as a temperature the movable layer is exposed to fluctuates.

The non-conductive layer can include one or more layers of a dielectric material, for example, silicon oxynitride (SiON) or SiO₂. In some implementations, the non-conductive layer can be a stack of layers, such as, for example, a SiO₂/SiON/SiO₂ tri-layer stack. Further, in some implementations, the first conductive layer of each display element is electrically connected to the first conductive layer of any adjacent display element in the line of display elements. Similarly, the second conductive layer of each display element can be electrically connected to the second conductive layer of any adjacent display element in the line of display elements.

In some implementations, the optical stack can include a first electrode, and the first conductive layer and the second conductive layer can form at least a portion of a second electrode. In this way, the movable layer of each display element can be configured to move between an actuated position and a relaxed positioned based on a voltage applied across the first and second electrodes. Thus, each display element can interferometrically modulate light incident thereon to selectively absorb and/or reflect light incident thereon using principles of optical interferences.

As shown in block 1103, the method 1100 also includes forming at least one conductive via in the movable layer of at least one display element. The at least one conductive via can be formed between the first conductive layer of the display element and the second conductive layer of the display element. In this way, the first conductive layer and the second conductive layer can be electrically connected to one another and the overall resistance and impedance of the movable layer can be reduced. In some implementations, forming the at least one conductive via can include etching the non-conductive layer of at least one of the display elements before forming the second conductive layer. The non-conductive layer can be etched between the first conductive layer and a surface of the non-conductive layer opposite to the first conductive layer so as to form a void or space through the non-conductive layer. The second conductive layer can then be formed over the non-conductive layer such that the material used to form the second conductive layer can pass or seep into the void or space through the non-conductive layer until reaching the first conductive layer so as to form a conductive via. Thus, the at least one conductive via can include the same material(s) as the second conductive layer. In some implementations, the at least one conductive via includes a different material than at least one of the first conductive layer and the second conductive layer.

As discussed in more detail below, the at least one conductive via can be formed in various locations of the at least one display element. For example, the at least one conductive via can be disposed in a tether area of at least one of the display elements. That is to say, the at least one conductive via can be disposed near a post structure that supports a movable layer above an electrode or optical stack. In some implementations, the at least one conductive via can be disposed along an edge of at least one of the plurality of display elements. In other words, the at least one conductive via can extend through the non-conductive layer between the first conductive layer and the second conductive layer along an edge of the movable layer. In some implementations, the at least one conductive via can be formed in the center of a display element. Further, in some implementations, the at least one conductive via can be formed underneath a black mask structure of an EMS device. In this way, the at least one conductive via can be shielded by the mask structure. In some implementations, each display element can include at least one conductive via and in other implementations, not every display element includes a conductive via. In some implementations, a display element can include a plurality of conductive vias, for example, 2-10 conductive vias, and in some implementations, even more than 10 conductive vias.

FIGS. 11B-11E show cross-sectional views of an example process of manufacturing the EMS device of FIGS. 10A and 10B in accordance with the example method of FIG. 11A.

FIG. 11B illustrates the optical stacks 1016, the insulating layers 1035, and the substrate 1020 of FIG. 10B. A sacrificial layer 1030 is disposed over the optical stacks 1016 and the first conductive layer 1014a is disposed over the sacrificial layer 1030. In some implementations, the sacrificial layer 1030 includes a photoresist material or other dissolvable material, for example, a xenon difluoride (XeF₂)-etchable such as Mo or a-Si. Deposition of the sacrificial layer 1030 can be carried out using deposition techniques such as physical vapor deposition (PVD, e.g., sputtering), plasma-enhanced chemical vapor deposition (PECVD), thermal chemical vapor deposition (thermal CVD), or spin-coating. The first conductive layer 1014a can be formed using one or more deposition steps along with one or more patterning, masking, and/or etching steps. In some implementations, the first conductive layer includes an Al alloy, for example, an Al alloy having 0.5% Cu.

FIG. 11C illustrates the non-conductive layer 1014b deposited over the first conductive layer 1014a depicted in FIG. 11B. As discussed above, the non-conductive layer can include one or more dielectric layers, for example, one or more layers of silicon oxynitride (SiON). FIG. 11D illustrates the non-conductive layer 1014b after it has been patterned and etched to create voids or holes 1027 extending through the non-conductive layer 1014b to the first conductive layer 1014a. The non-conductive layer 1014b can be patterned and etched using a variety of techniques, including photolithography and dry etching.

FIG. 11E illustrates the movable layer 1004b after the second conductive layer 1014c has been deposited over the non-conductive layer 1014b. The second conductive layer 1014c can include any conductive material(s), for example, an Al alloy having 0.5% Cu. In some implementations, the material deposited to form the second conductive layer 1014c extends or seeps through the voids 1027 of FIG. 11D to form conductive vias 1025b as shown in FIG. 11E. In such an implementation, the conductive vias 1025b electrically connect the first conductive layer 1014a and the second conductive layer 1014c through the non-conductive layer 1014b between the ends of the movable layer. After the second conductive layer 1014c has been deposited, the movable layer 1004b formed by the first conductive layer 1014a, non-conductive layer 1014b, and second conductive layer 1014c can be patterned and etched to form slots 1090b. As discussed above, such slots 1090b can separate portions of the movable layer 1004b from one another to avoid mechanical cross-talk between the display elements by the movable layer 1004b and the optical stacks 1016.

In FIG. 11E, the slots 1090b can be formed in some implementations by patterning and etching the first conductive layer 1014a, the non-conductive layer 1014b, and the second conductive layer 1014c altogether. An alternative process in some implementations is to pattern and etch the slots 1090b using multiple steps, with each step patterning and etching one or two of the three layers (e.g., the first conductive layer 1014a, the non-conductive layer 1014b, and the second conductive layer 1014c). For example, the first conductive layer 1014a can be patterned and etched to form slots 1090b after being deposited over the sacrificial layer 1030. The non-conductive layer 1014b can be then deposited over the first conductive layer 1014a, and can be patterned and etched to form holes 1027 and slots 1090b. The second conductive layer 1014c can be deposited over the first conductive layer 1014a and the non-conductive layer 1014b to form the conductive vias 1025b and can be patterned and etched to form slots 1090b in the layer. In implementations where conductive vias 1025b are formed in the slots 1090b, the multiple step process may be easier to implement.

From the configuration illustrated in FIG. 11E, the sacrificial layer 1030 can be removed which results in the EMS device illustrated in FIG. 10B. The sacrificial layer 1030 can be removed by dry chemical etching, for example, by exposing the sacrificial layer to a gaseous or vaporous etchant, including vapors derived from solid XeF₂ for a period of time that is effective to remove the desired amount of material, typically selectively relative to the structures surrounding the sacrificial layer 1030. Other etching methods, for example, wet etching and/or plasma etching, also can be used. Removing the sacrificial layer 1030 results in the gaps 1021 illustrated in FIG. 10B between the movable layer 1004b and the optical stacks 1016. In some implementations, the gaps 1021 allow the movable layer 1004b to move relative to the substrate 1020.

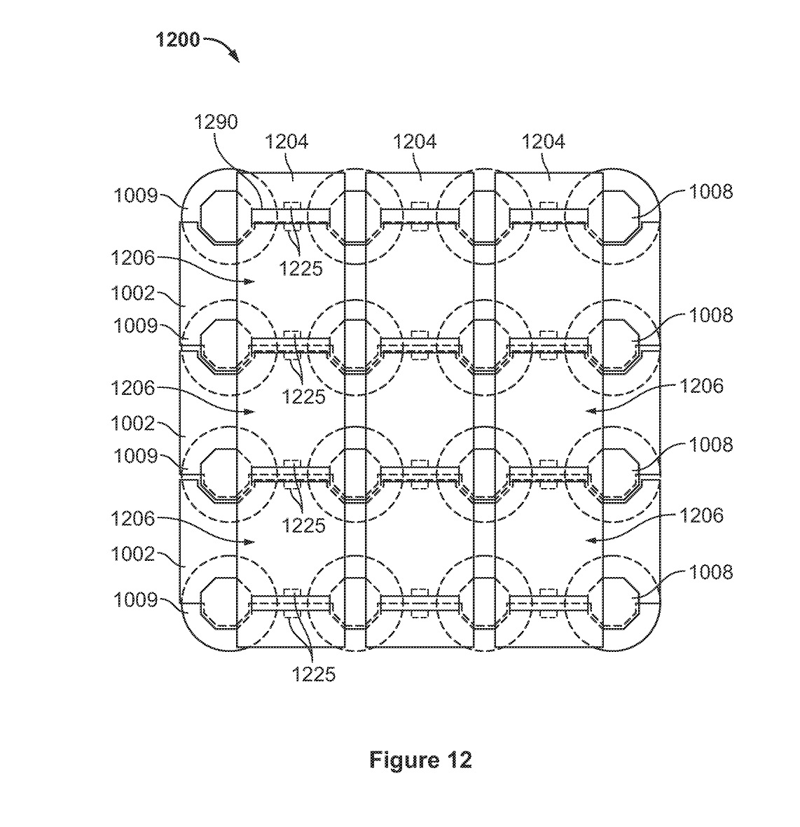

FIG. 10A illustrates conductive vias 1025 having circular cross-sectional shapes and being disposed in the centers of the display elements 1006. Additionally, the conductive vias 1025 illustrated in FIG. 10A are each similarly sized. However, in some other implementations, conductive vias extending through a non-conductive layer between a first conductive layer and a second conductive layer in a movable layer can be differently sized, shaped, and positioned than the conductive vias 1025 of FIG. 10A, as described below with reference to FIGS. 12-17.

FIG. 12 shows a bottom plan view of a portion of an example of an EMS device 1200 having a plurality of movable layers 1204 each having a plurality of conductive vias 1225 extending between the first conductive layer and the second conductive layer along opposite edges of the display elements 1206 formed by the movable layers 1204 and a plurality of underlying electrodes 1002. Similar to the EMS device 1000 discussed above with reference to FIG. 10A, the electrodes 1002 of the EMS device 1200 are disposed in rows and the movable layers 1204 are disposed in columns extending perpendicular to the electrodes 1002. The overlapping portions of the electrodes 1002 and the movable layers 1204 define nine display elements 1206. Supports 1008 are disposed at corner regions of each display element 1206 and are configured to support edge portions of the movable layers 1204 relative to the electrodes 1002. The EMS device 1200 also includes black mask structures 1009 disposed under the electrodes 1002 and movable layers 1204.

In some implementations, each movable layer 1204 can include a plurality of conductive vias 1225. The conductive vias 1225 can be rectangular shaped and are disposed on opposite edges of the display elements 1206. In some implementations, the conductive vias 1225 are disposed within the movable layers 1204 over the edges of the electrodes 1002 that extend underneath the movable layers 1204 (as viewed in FIG. 12). In some implementations, the conductive vias 1225 can be disposed in a movable layer 1204 between adjacent support structures 1008, as illustrated in FIG. 12. In other words, the conductive vias 1225 can be disposed in a tether area or region of the movable layer 1204 proximal to the support structures 1008. In such an implementation, the conductive vias 1225 can affect a stiffness of the movable layer 1204 near the support structures 1008.

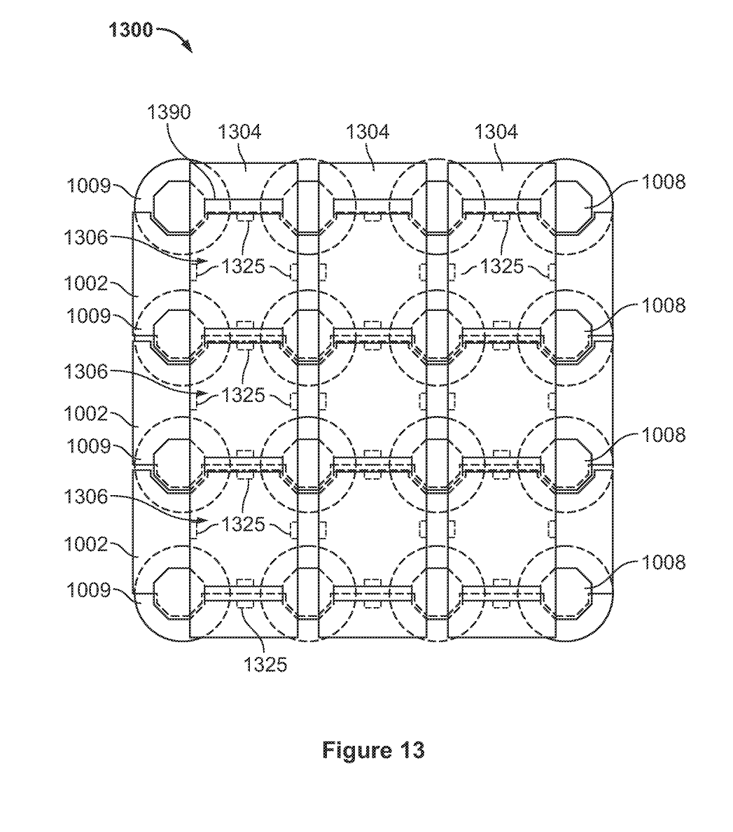

FIG. 13 shows a bottom plan view of a portion of an example of an EMS device 1300 having a plurality of movable layers 1304 each having a plurality of conductive vias 1304 extending between the first conductive layer and the second conductive layer along the four edges of the display elements 1306 formed by the movable layers 1304 and a plurality of underlying electrodes 1002. The EMS device 1300 of FIG. 13 is similar to the EMS device 1200 of FIG. 12 in that the EMS device 1300 includes electrodes 1002, support structures 1008, and black mask structures. However, each movable layer 1304 of FIG. 13 includes a conductive via 1325 having a rectangular cross-sectional shape along all four edges of each display element 1306. That is to say, the conductive vias 1325 are disposed within the movable layers 1304 over the edges of the electrodes 1002 in each display element 1306 and along the edges of the movable layers 1304 in each display element 1306. Thus, the movable layers 1304 of FIG. 13 have more conductive vias than the movable layers 1204 of FIG. 12. Accordingly, the resistances of the movable layers 1204 can be greater than the resistances of the movable layers 1304.

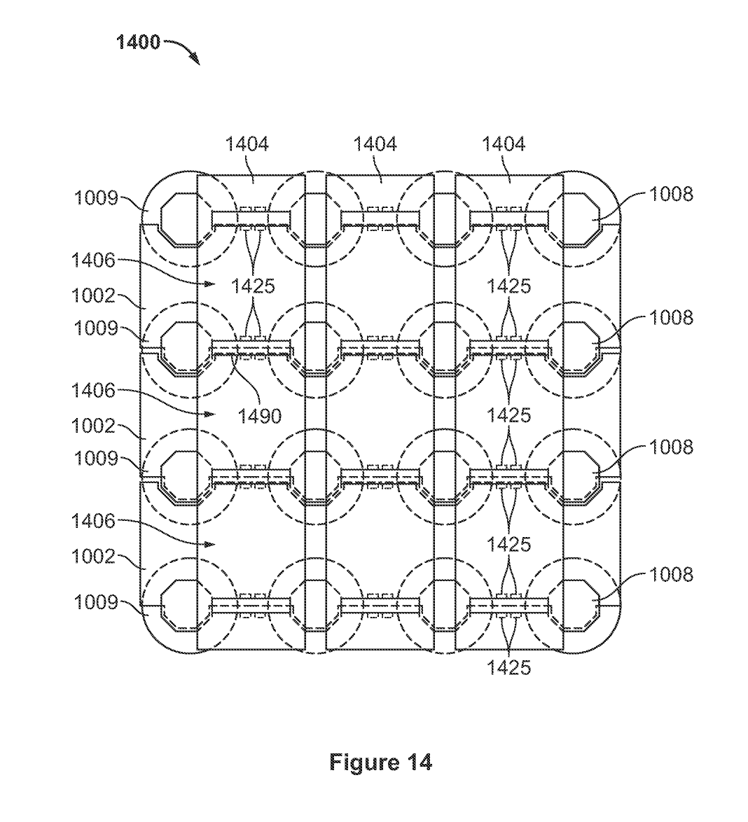

FIG. 14 shows a bottom plan view of a portion of an example of an EMS device 1400 having a plurality of movable layers 1404 each having a plurality of conductive vias 1425 extending between the first conductive layer and the second conductive layer in pairs along opposite edges of the display elements formed by the movable layers and a plurality of underlying electrodes 1002. The conductive vias 1425 are rectangular shaped and are disposed in pairs on opposite edges of the display elements 1406. That is to say, each display element 1406 includes a pair of rectangular shaped conductive vias 1425 disposed side by side along a first edge of the display element overlying an edge of an electrode. Further, each display element 1406 includes another pair of conductive vias 1425 disposed side by side along a second edge of the display element overlying another edge of the electrode. In some implementations, the pairs of conductive vias 1425 can be disposed in a movable layer 1404 between adjacent support structures 1008.

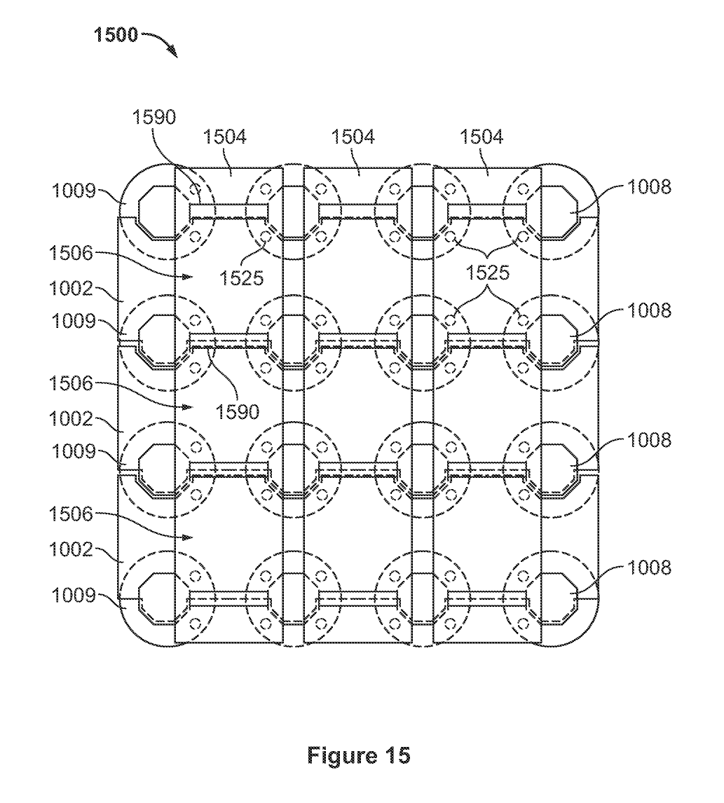

FIG. 15 shows a bottom plan view of a portion of an example of an EMS device 1500 having a plurality of movable layers 1504 each having a plurality of circular conductive vias 1525 extending between the first conductive layer and the second conductive layer over the black mask structures 1009 of the display. As illustrated, in some implementations the conductive vias 1525 have circular or curvilinear cross-sectional shapes and are differently sized than the conductive vias of FIGS. 10A and 12-14 (e.g., a cross-sectional area of each conductive via 1525 is different than the cross-sectional areas of the conductive vias of FIGS. 10A and 12-14).

In some implementations, the conductive vias 1525 can be disposed in portions of the movable layers 1504 that overlap the black mask structures 1009 of the EMS device 1500. In this way, in contrast to the conductive vias schematically illustrated in FIGS. 10A and 12-14, the conductive vias 1525 can be shielded or masked by the black mask structures 1009 when the EMS device 1500 is viewed from the opposite side shown in FIG. 15. Thus, in such implementations, the conductive vias 1525 can be configured so as to not affect the interferometrically modulated reflectance from the EMS device 1500. Further, as illustrated, in some implementations the conductive vias 1525 can be disposed in a tether area of a display element 1506. Thus, the conductive vias 1525 can reduce the stiffness of the movable layer 1504 near the support structures 1008.

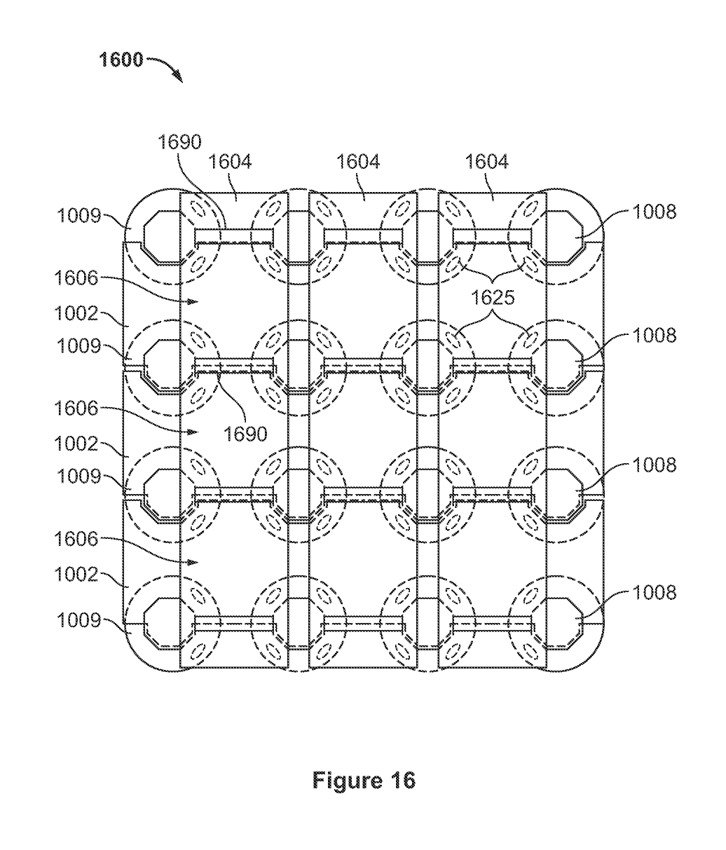

FIG. 16 shows a bottom plan view of a portion of an example of an EMS device 1600 having a plurality of movable layers 1604 each having a plurality of oval shaped conductive vias 1625 extending between the first conductive layer and the second conductive layer over the mask structures 1009 of the display. Similar to the conductive vias 1525 of FIG. 15, the conductive vias 1625 can overlap the black mask structures 1009 in a tether area of a display element 1606. Thus, the conductive vias 1625 can be configured to not affect the reflectance from the EMS device 1600. However, in contrast to the conductive vias 1525 illustrated in FIG. 15, the conductive vias 1625 are differently sized and shaped. Accordingly, the movable layers 1604 may have different stiffness or rigidity characteristics than the movable layers 1504 of FIG. 15. For example, the movable layers 1604 can be less stiff neat the support structures 1008 than the movable layers 1604 of FIG. 15.

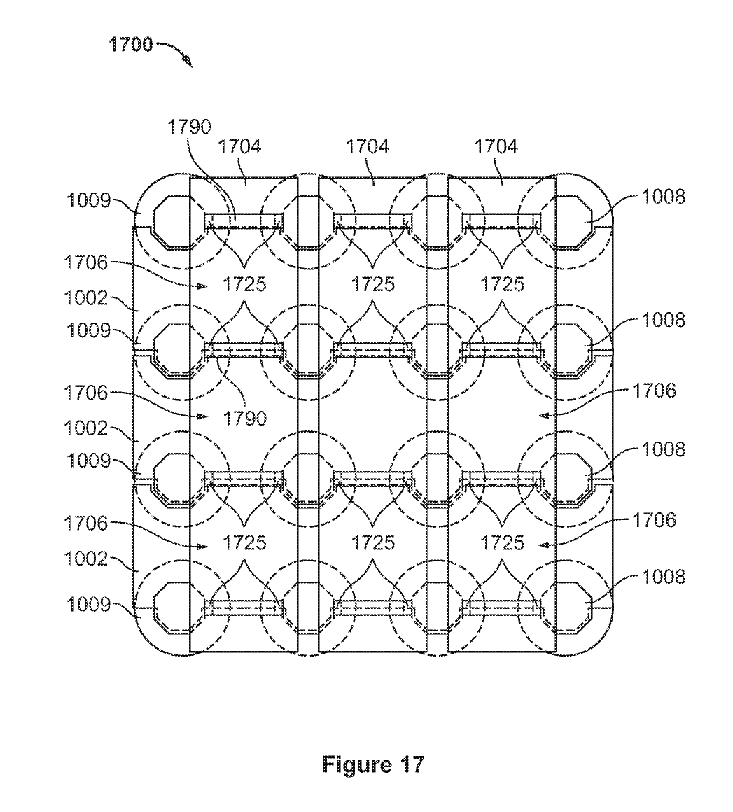

FIG. 17 shows a bottom plan view of a portion of an example of an EMS device 1700 having a plurality of movable layers 1704 each having a plurality of conductive vias 1725 extending through the non-conductive layer between the first conductive layer and the second conductive layer. In the illustrated implementation, the conductive vias 1725 are disposed within slots 1790 formed in the movable layers 1704 between the display elements 1706. That is to say, in some implementations, the conductive vias 1725 may be positioned between display elements 1706 by forming the conductive vias 1725 in the slots 1790. In such implementations, the conductive vias 1725 can have a width which is the same as the width of the slots 1790. In some implementations, the width of the slots 1790 can be between 2 μm and 4 μm, for example, 3 μm. Each conductive via 1725 can have a length of between 0.5 μm and 5 μm, for example, 1.5 μm. Larger lengths for the conductive vias 1725 can reduce the resistance and RC delay for higher frame rates. However, because the first conductive layer and the second conductive layer of the movable layers 1704 can be deposited in the slots 1790, which may induce mechanical cross-talk between display elements 1706, the lengths of the conductive vias 1725 can be optimized to have the greatest length which still does not induce mechanical cross-talk between display elements 1706. Further, because the conductive vias 1725 are formed between the display elements 1706, the conductive vias 1725 may not affect the reflective characteristics of each display element 1706.

As understood by comparing FIGS. 10A and 12-17, EMS devices can include movable layers having various numbers of conductive vias. Also, the conductive vias formed in movable layers can have various sizes, shapes, and positions relative to the rest of the EMS device. For example, conductive vias can have circular, oval-shaped, curvilinear, polygonal, rectangular, square, or other cross-sectional shapes. Additionally, conductive vias can be disposed, for example, between display elements, in tether areas (such as near support structures), along one or more edges of a display element, in the center of a display element, and/or such that the conductive vias are masked or shielded by one or more black mask structures. Further, the size or cross-sectional area of conductive vias can vary. In some implementations, a conductive via can have a cross-sectional area of between 2 μm² and 20 μm². For example, a conductive via can have a cross-sectional area of between 3 μm² and 4 μm².

In some implementations, the size, shape, quantity, and/or positioning of conductive vias can be chosen based on the desired stiffness of the movable layer. For example, conductive vias can be disposed in a tether area of a movable layer to reduce the stiffness of the movable layer. In some implementations, the size, shape, quantity, and/or positioning of conductive vias can be chosen based on the desired reflective properties of the movable layer. In this way, an EMS device having movable layers with one or more conductive vias can be configured to selectively absorb and/or reflect light incident thereon using principles of optical interference and absorption. Furthermore, the one or more conductive vias of such movable layers can lower the effective resistance and/or capacitance of the movable layers. Also, the one or more conductive vias of such movable layers can prevent lineouts of the movable layers when a portion of a first conductive layer and/or second conductive layer breaks due to an impactful force.

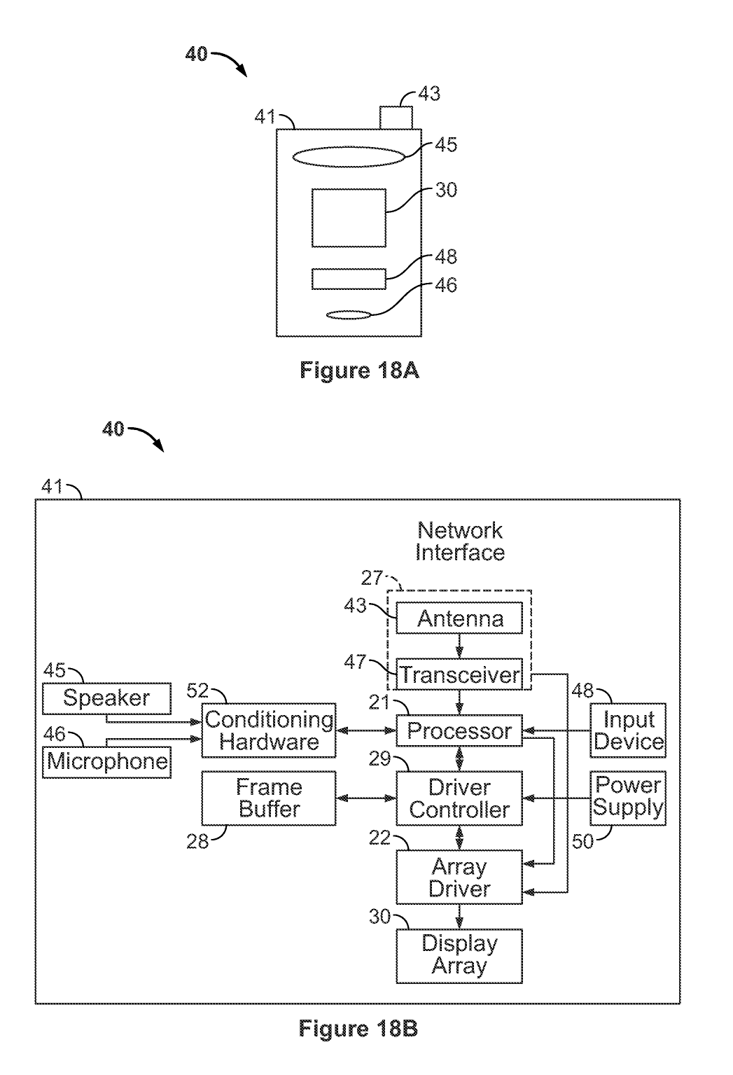

FIGS. 18A and 18B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a plurality of display elements disposed in a line, each display element including:
a partially transmissive and partially reflective optical stack; and
a movable layer disposed over at least a portion of the optical stack so as to at least partially define a cavity between the movable layer and the optical stack, the movable layer being at least partially reflective and including a first conductive layer, a second conductive layer, and a non-conductive layer disposed between the first conductive layer and the second conductive layer,
wherein the first conductive layer of each display element is electrically connected to the first conductive layer of any adjacent display element in the line of display elements and the second conductive layer of each display element is electrically connected to the second conductive layer of any adjacent display element in the line of display elements, and
wherein at least one of the plurality of display elements includes at least one conductive via disposed in the movable layer through the non-conductive layer electrically connecting the first conductive layer and the second conductive layer.

2. The apparatus of claim 1, wherein the optical stack includes a first electrode, and wherein the first conductive layer and the second conductive layer form at least a portion of a second electrode, and wherein the movable layer is configured to move between an actuated position and a relaxed position based on a voltage applied to the first and second electrodes.

3. The apparatus of claim 1, wherein the at least one conductive via has a cross-sectional area of between 3 microns² and 10 microns².

4. The apparatus of claim 1, wherein at least one of the first conductive layer and the second conductive layer include an aluminum alloy.

5. The apparatus of claim 1, wherein the first conductive layer includes a reflective material disposed between the optical stack and the non-conductive layer.

6. The apparatus of claim 1, wherein the first conductive layer and the second conductive layer are configured to have a substantially similar coefficient of thermal expansion.

7. The apparatus of claim 1, wherein the non-conductive layer includes silicon oxynitride.

8. The apparatus of claim 1, wherein the at least one conductive via includes a conductive via disposed in a tether area of at least one of the plurality of display elements.

9. The apparatus of claim 1, wherein the at least one conductive via includes a conductive via disposed along an edge of at least one of the plurality of display elements.

10. The apparatus of claim 1, wherein the at least one conductive via is structured to have one of an oval-shaped cross-sectional area, a rectangular cross-sectional area, and a circular cross-sectional area.

11. The apparatus of claim 1, further comprising:
a processor that is configured to communicate with the plurality of display elements, the processor being configured to process image data; and
a memory device that is configured to communicate with the processor.

12. The apparatus of claim 11, further comprising:
a driver circuit configured to send at least one signal to the plurality of display elements; and
a controller configured to send at least a portion of the image data to the driver circuit.

13. The apparatus of claim 11, further comprising an image source module configured to send the image data to the processor, wherein the image source module includes at least one of a receiver, transceiver, and transmitter.

14. The apparatus of claim 13, further comprising an input device configured to receive input data and to communicate the input data to the processor.

15. A method of manufacturing an apparatus, comprising:
forming a plurality of display elements disposed in a line, wherein forming each of the plurality of display elements includes:
forming a partially transmissive and partially reflective optical stack;
depositing a sacrificial layer over the optical stack;
forming a movable layer over the sacrificial layer and optical stack such that when the sacrificial layer is removed the movable layer is movable towards and away from the optical stack, wherein forming the movable layer includes forming a first conductive layer, forming a non-conductive layer over the first conductive layer, and forming a second conductive layer over the non-conductive layer,
wherein the first conductive layer of each display element is electrically connected to the first conductive layer of any adjacent display element in the line of display elements and wherein the second conductive layer of each display element is electrically connected to the second conductive layer of any adjacent display element in the line of display elements; and
forming at least one conductive via in the movable layer of at least one display element between the first conductive layer and the second conductive layer.

16. The method of claim 15, wherein forming the at least one conductive via comprises:
etching the non-conductive layer of at least one of the display elements between the first conductive layer and a surface of the non-conductive layer opposite to the first conductive layer of the at least one display element; and
forming the second conductive layer over the non-conductive layer of the at least one display element.

17. The method of claim 15, wherein the optical stack includes a first electrode, and wherein the first conductive layer and the second conductive layer form at least a portion of a second electrode, and wherein the movable layer is configured to move between an actuated position and a relaxed position based on a voltage applied across the first and second electrodes.

18. The method of claim 15, wherein at least one of the first conductive layer includes an aluminum alloy.

19. The method of claim 15, wherein forming the at least one conductive via includes forming a conductive via disposed in a tether area of at least one of the plurality of display elements.

20. The method of claim 19, wherein forming the at least one conductive via includes forming a conductive via disposed along an edge of at least one of the plurality of display elements.

21. An apparatus comprising:
a plurality of display elements disposed in a line, each display element including:
means for partially transmitting and partially reflecting light; and
a movable layer disposed over at least a portion of the partially transmitting and partially reflecting means so as to at least partially define a cavity between the movable layer and the partially transmitting and partially reflecting means, the movable layer being at least partially reflective and including first means for conducting electricity, second means for conducting electricity, and a non-conductive layer disposed between the first conductive means and the second conductive means,
wherein the first conductive means of each display element are electrically connected to the first conductive means of any adjacent display element in the line of display elements and wherein the second conductive means of each display element are electrically connected to the second conductive means of any adjacent display element in the line of display elements; and
wherein at least one of the display elements includes at least one means for electrically connecting the first conductive means and the second conductive means through the non-conductive layer.

22. The apparatus of claim 21, wherein the first conductive means includes a first conductive layer.

23. The apparatus of claim 21, wherein the second conductive means includes a second conductive layer.

24. The apparatus of claim 21, wherein the electrically connecting means includes at least one conductive via.

25. An apparatus comprising:
a plurality of partially transmissive and partially reflective optical stacks; and
a movable layer extending over each of the plurality of optical stacks and defining a plurality of display elements between each of the optical stacks and the movable layer, at least a portion of the movable layer being movable towards and away from at least one of the plurality of optical stacks based on a voltage applied across the at least one of the plurality of optical stacks and the movable layer, the movable layer including:
a first conductive layer;
a second conductive layer;
a non-conductive layer disposed between the first conductive layer and the second conductive layer; and
at least one conductive via electrically connecting the first conductive layer and the second conductive layer through the non-conductive layer.

26. The apparatus of claim 25, wherein the at least one conductive via has a cross-sectional area of between 3 microns² and 10 microns².

27. The apparatus of claim 25, wherein the at least one conductive via includes a conductive via disposed between two of the plurality of display elements.

28. The apparatus of claim 25, wherein the at least one conductive via includes a conductive via disposed in the center of at least one of the plurality of display elements.

29. The apparatus of claim 25, wherein the at least one conductive via is structured to have one of an oval-shaped cross-sectional area, a rectangular cross-sectional area, and a circular cross-sectional area.

30. The apparatus of claim 25, wherein the movable layer includes at least one slot disposed between two adjacent display elements.

31. The apparatus of claim 30, wherein the at least one conductive via is disposed in the at least one slot.
